(19) United States
(12) Patent Application Publication
(10) Pub. No.: US 2003/0043519 A1
(43) Pub. Date: Mar. 6, 2003

(54) Over-voltage protection and disconnect circuit apparatus and method

(76) Inventors: Anthony M. Wu, San Francisco, CA (US); Demian Martin, San Leandro, CA (US)

Correspondence Address: LARIVIERE, GRUBMAN & PAYNE, LLP, 1 LOWER RAGSDALE, BLDG. 1, SUITE 130, P.O. BOX 3140, MONTEREY, CA, 93942, US

(21) Appl. No.: 09/946,774

(22) Filed: Sep. 4, 2001

(51) Int. Cl. H02H 3/20

(52) U.S. Cl. 361/91.1

(57) ABSTRACT

An apparatus and method for preventing the overheating and destruction of MOVs in an over-voltage protection circuit by providing an efficient circuit configuration, using a minimal number of components mounted in an efficient manner, to assure a rapid disconnect of the electrical power when designated MOVs begin to overheat. MOVs are incorporated in a way that provides capacity for dissipating very large transient over-voltage surges without increasing the number of thermal fuses needed for protection from overheating of the MOVs. A minimal number of thermal fuses are incorporated in such a way that a disconnection from the electrical supply is assured where necessary while the risk of acrid smoke and fire from overheated components is minimized. Thermal fuses having a relatively low opening temperature are installed using a method that avoids placing thermal stress on the fuses.

### BACKGROUND OF INVENTION

Homes and offices are filled with electric and electronic equipment. Such equipment is vulnerable to damage by over-voltage—spikes and surges—in the supplied electricity. One common means of protecting against over-voltage is the use of protection devices able to absorb transient over-voltage conditions and disconnect from a circuit in a sustained over-voltage condition. It is known in the art to use MOVs (Metal Oxide Varistors) to absorb transient over-voltages and to disconnect from a sustained over-voltage circuit by using a thermal fuse to sense when an MOV has become overheated.

In order to provide a high level of transient over-voltage protection, it is usual to incorporate several MOVs of the same rating into a protection device. The MOVs are generally installed into the device by soldering them. The several MOVs are mounted in parallel. In theory a large number of MOVs in parallel provide a very high level of transient over-voltage protection, and such a theoretically high level of protection is important for the commercial marketing of protection devices. In practice, in a sufficiently large surge, the weakest one of several parallel MOVs of the same rating will heat up and fail, and the other MOVs will not contribute any protection to prevent such a failure.

A thermal fuse is used to sense the overheating of the MOVs because of a sustained over-voltage condition, and to disconnect from the electrical circuit. The thermal fuses are difficult to install into the protection device because they cannot be easily soldered, since soldering produces heat which would melt the fuse. In the art, it is common to have a fuse between two MOVs and in close proximity to the two MOVs so that the thermal fuse can sense any heat coming from the MOVs. Where more than two MOVs are used, it is difficult to mount a single thermal fuse that effectively monitors all of the MOVs. Where several MOVs of the size and type used in surge protection devices are installed, the physical space occupied by the installed components spans two inches or more. It would be difficult to place one thermal fuse in such a way as to be equally affected by heat from each of the several MOVs. Because of the variations of response tolerated in MOVs having the same rating, it is not possible to predict which of several MOVs at the same rating would overheat first and should therefore be placed in closer proximity to a thermal fuse. Where several MOVs are installed, it is necessary to install several thermal fuses in order to obtain adequate protection of the circuit.

It is desirable to break the circuit quickly because the MOV will produce an acrid smoke and present a danger of the protection device melting or catching fire. It is sometimes desirable to place several MOVs in parallel to obtain a higher level of over-voltage protection. Where one thermal fuse is placed in series with more than two MOVs, it is difficult to physically locate the thermal fuse equally close to each MOV. MOVs are manufactured to fall within certain tolerances close to their stated rating. In a series of, for example, ten MOVs with the same voltage rating, it is not possible to know which one will become hot first. If one thermal fuse is placed in series with the ten MOVs, it is possible that the MOV that first becomes hot will be located at a greater distance from the thermal fuse than the MOVs that remain cool. In such a situation, one MOV or more could overheat, start smoking, and present a fire hazard before the thermal fuse was able to sense the overheating and break the circuit.

Typically, thermal fuses rated to open at 105C are used in protection devices. Although it would be an advantage to use fuses rated to open at lower temperatures, the low-temperature fuses are not used because of the difficulties presented by the present methods of installing them. The installation of a thermal fuse is a difficult and therefore expensive process. The thermal fuse is itself an expensive component. The installation of a thermal fuse is difficult because it cannot be soldered in place the way most electronic components can be. The heat sensitivity of the thermal fuse prevents soldering by normal methods. Even with a heat sink and soldering at low temperatures, the thermal fuse is subjected to thermal stress which either burns open the fuse or affects its accuracy. Further complicating the process, the thermal fuse must be installed in such a way that it is able to sense the heat emitted from a failing MOV. This requires an installation in close proximity to the MOVs.

### SUMMARY OF INVENTION

The present invention is an apparatus and method which prevents the overheating and destruction of MOVs in an over-voltage protection circuit by providing an efficient circuit configuration, using a minimal number of components mounted in an efficient manner, to assure a rapid disconnect of the electrical power when designated MOVs begin to overheat. MOVs are incorporated in a way that provides capacity for dissipating very large transient over-voltage surges without increasing the number of thermal fuses needed for protection from overheating of the MOVs. A minimal number of thermal fuses are incorporated in such a way that a disconnection from the electrical supply is assured where necessary while the risk of acrid smoke and fire from overheated components is minimized. Thermal fuses having a relatively low opening temperature are installed using a method that avoids placing thermal stress on the fuses.

### BRIEF DESCRIPTION OF DRAWINGS

FIG. 1 shows a circuit diagram of the invention with the close physical proximity of certain components emphasized by dashed circles.

FIG. 2 shows a circuit diagram of the invention.

FIG. 3 shows a circuit diagram of a thermal fuse mounted physically between two MOVs.

FIG. 4 illustrates the physical installation of a thermal fuse between two MOVs and the application of compound and the wrapping with a thermal blanket.

FIG. 5 illustrates an alternative embodiment of an installed thermal fuse between two MOVs held in contact by a clip.

FIG. 6 illustrates an alternative embodiment of an installed thermal fuse between two MOVs and the application of a thermal epoxy.

### DETAILED DESCRIPTION

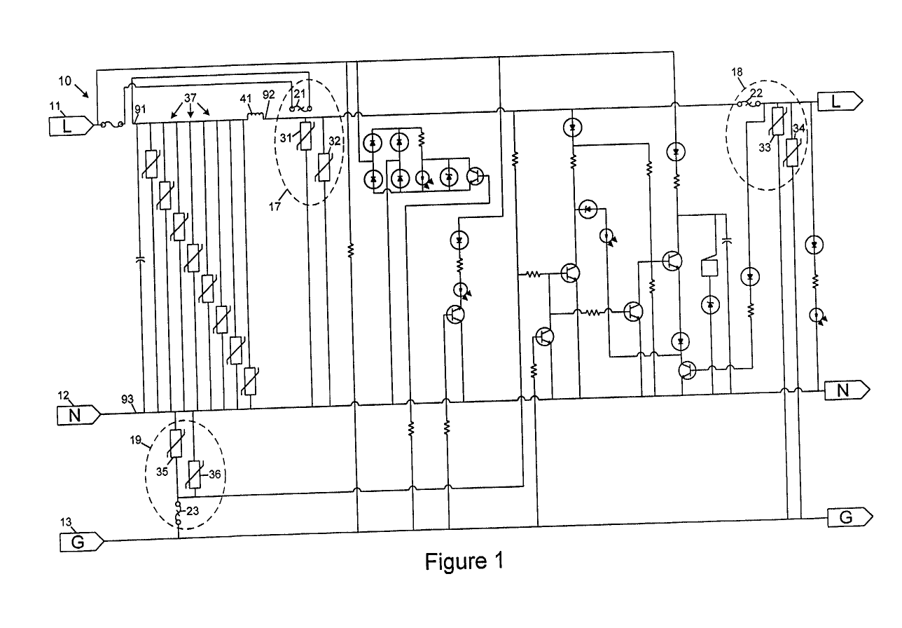

An aspect of the invention is shown in FIG. 1. The circuit diagram of an over-voltage protection and disconnect circuit apparatus is shown 10 having inputs for hot line 11 neutral 12 and ground 13. Three combinations comprising a thermal fuse and two MOVs (Metal Oxide Varistors) are shown, providing protection for hot line to neutral 17, hot line to ground 18 and neutral to ground 19. In each combination, a thermal fuse is placed electrically ahead of, but physically between two MOVs in parallel. For the hot line to neutral path, thermal fuse 21 is placed physically between two MOVs 31,32. For the hot line to ground path, thermal fuse 22 is placed physically between two MOVs 33,34. For the neutral to ground path, thermal fuse 23 is placed physically between two MOVs 35,36. Placement of the thermal fuses between two MOVs allows for efficient sensing of heat from the MOVs by the thermal fuse, especially when the fuses are installed using the method of this invention. Other physical arrangements of the thermal fuse and MOVs could be effective, as long as close proximity and an efficient sensing of heat from the MOVs is maintained.

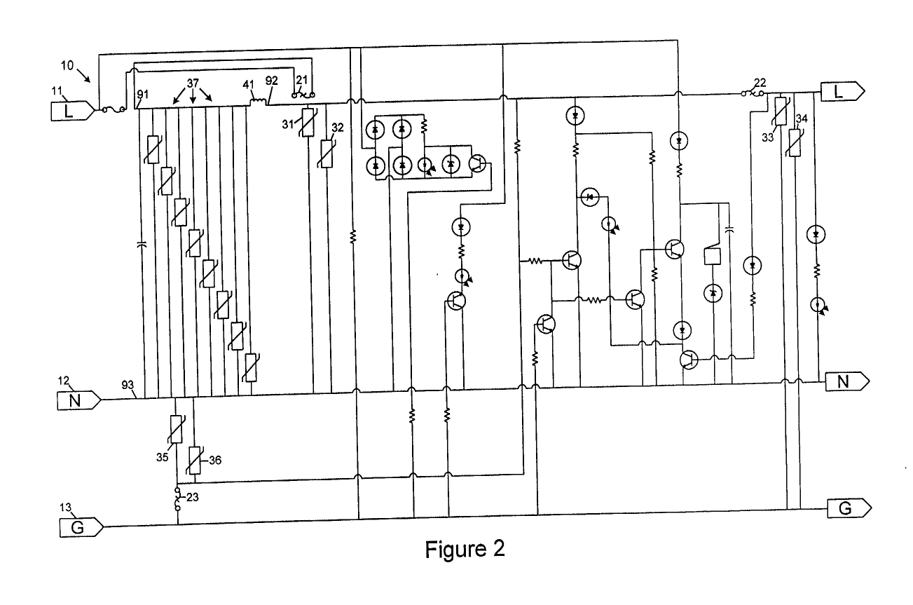

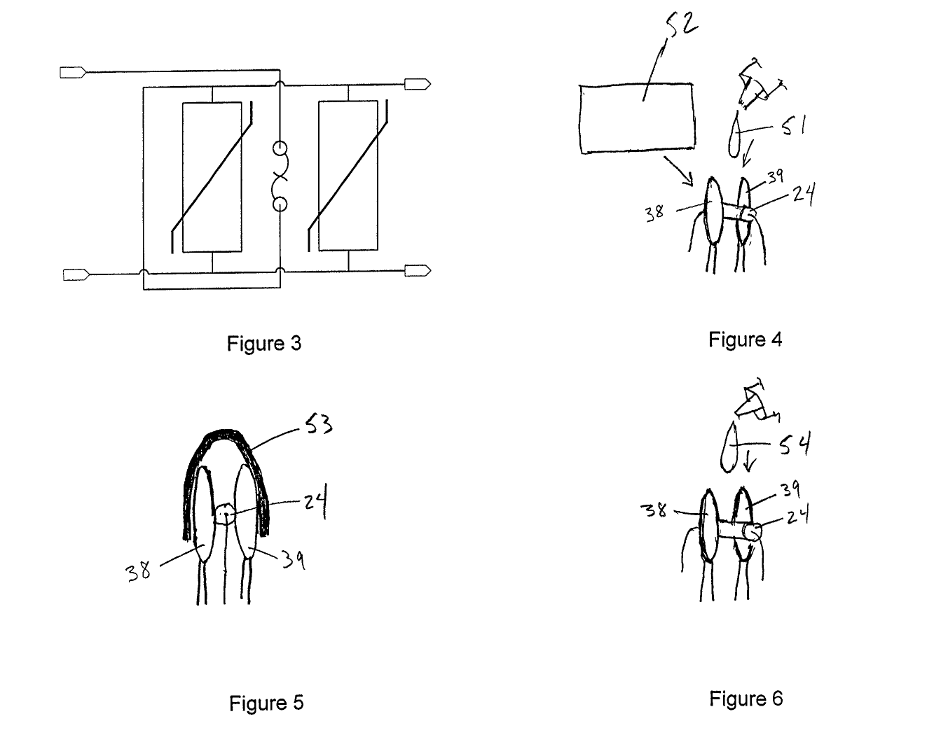

FIG. 2 shows the same circuit diagram without added emphasis on the MOV and thermal fuse combinations. A diagram for a typical, functioning protection device is shown, including indicator lights and a warning buzzer. The present invention is shown in its environment of a complete protection device. The typical circuit design for such a protection device is known in the art and is not further described here.

As shown in FIG. 2, several additional MOVs 37 are installed in parallel in the hot line to neutral path. These additional MOVs provide additional protection to the circuit. Eight additional MOVs are illustrated, but the number of additional MOVs may be varied up or down. Additional MOVs could also be added to the hot line to ground path and the neutral to ground path, although little practical benefit would be realized from doing so.

In this invention the two MOVs 31,32 which are installed in close physical proximity to the thermal fuse 21 are rated at a lower pass-through voltage rating than the additional MOVs 37 installed in parallel. In a sustained over-voltage condition, the MOVs 31,32 rated at a lower voltage will overheat before the additional MOVs rated at a higher voltage. Since the thermal fuse 21 is installed in close physical proximity to the lower-rated MOVs 31,32, and since the lower-rated MOVs will overheat before the higher-rated MOVs 37, the thermal fuse is able to provide adequate protection for the whole path. The MOVs rated at a lower voltage will become hotter faster than the higher voltage MOVs connected in parallel. In a sustained over-voltage condition the two lower voltage MOVs will heat up and trip the thermal fuse before any of the higher voltage MOVs overheat. Upon the tripping of the thermal fuse, the circuit will open and the apparatus will have performed its function of disconnecting the circuit due to a sustained over-voltage.

An optional impedance, shown as an inductor 41 in FIG. 2 placed on the hot line behind the additional higher-voltage MOVs 37 and ahead of the selected lower-voltage MOVs 31,32 serves to insure that different over-voltage conditions are directed to the proper MOVs. This impedance will be referred to as the directing impedance 41. An inductive wire could be used. Other ways of providing impedance could be used, such as a resistor. This directing impedance is optional to the functioning of the invention.

The operation of the invention with the optional directing impedance will be analysed by examining the current and voltage across two paths in the circuit. The path before the directing impedance runs from a point 91 on the hot line before the directing impedance to a point 93 on neutral. The path after the directing impedance runs from a point 92 on the hot line behind the directing impedance 41 to a point 93 on neutral. In a high voltage, high current surge, the directing impedance will drop voltage across itself causing the additional higher-voltage MOVs 37 which are placed ahead of the directing impedance to conduct a large part of the surge. A smaller portion of the surge will be directed to the selected lower-voltage MOVs 31,32 behind the directing impedance. If the surge is of sufficient duration, one or both of the selected lower-voltage MOVs 31,32 will heat up and cause the thermal fuse 21 to open and disconnect the circuit. In a low voltage, low current surge, the directing impedance 41 will not drop much voltage and the selected lower-voltage MOVs 31,32 behind the directing impedance 41 will take an equal share of the surge. If the surge is of sufficient duration, one or both of the selected lower-voltage MOVs 31,32 will heat up, before any of the additional higher-voltage MOVs 37 heat up, and the thermal fuse 21 will open and disconnect the circuit. In this way, the invention makes efficient use of the additional higher-voltage MOVs when needed for very large surges, but avoids the need to thermally monitor those additional higher-voltage MOVs since the selected lower-voltage MOVs will always heat up more quickly.

For example, in a current surge of 3000 Amps, the voltage on the path before the directing impedance will be approximately 150 Volts higher than on the path after the directing impedance. Therefore the additional higher-voltage MOVs will take the surge. In a current surge of 5 Amps, there is very little difference in voltage between the path before the directing impedance and the path after the directing impedance. Therefore the surge will be taken by all MOVs. In either case, the selected lower-voltage MOVs 31,32 will heat up earlier and more than the additional higher-voltage MOVs 37 if the surge is of a long enough duration to cause any heating, and that heating of the selected lower-voltage MOVs 31,32 will cause the thermal fuse 21 to open and disconnect the circuit.

In a typical device for use in the United States, it would be appropriate to use MOVs with a pass-through voltage rating of 200V for the selected MOVs 31-36 in close proximity to the thermal fuses. The rating of the additional MOVs 37 would therefore be higher than 200V. A pass-through voltage rating of ff1V or 270V would be appropriate for the additional MOVs. For a device to be used in electrical systems having other voltages, the voltage ratings of the MOVs would be adjusted, keeping the relationship between the lower-voltage selected MOVs and the higher-voltage additional MOVs.

The arrangement of the thermal fuse between the two selected lower-voltage-rated MOVs ensures that the apparatus will perform properly while avoiding the manufacturing costs and complexity of mounting a thermal fuse in sufficiently close proximity to each of several MOVs protecting a circuit. In this invention, the selecting of two MOVs of a lower voltage rating allows the confident prediction that one or both of the selected MOVs will overheat before any of the MOVs of a higher voltage rating will, and that therefore the physical placement of a single thermal fuse between the two selected MOVs provides optimum protection for the circuit.

This invention uses a minimal number of thermal fuses, which is of practical benefit since thermal fuses are expensive to purchase and expensive to install. A thermal fuse rated to open at 85C is appropriate for this invention. Thermal fuses of other ratings, such as the standard 105C would also be appropriate. The use of a more sensitive thermal fuse provides for better assurance that an overheating MOV will be detected in time to disconnect the circuit and prevent smoking or burning of the components. In the present invention, the placement of thermal fuses near to selected MOVs and the efficient thermal coupling between the MOVs and the thermal fuse insure that no burning of any MOV will occur, thereby removing the risk of smoke and fire from the protection device.

An aspect of the invention is the method of mounting a thermal fuse as illustrated in FIG. 4. A thermal fuse 24 is placed into a socket. Alternatively, the thermal fuse is attached with screws or clips. The fuse is between two MOVs 38,39. Then a heat-conducting compound is applied, such as thermal grease 51, covering the thermal fuse and the two adjacent MOVs. Finally, a thermal blanket 52, such as a mylar tape, is placed around the entire assembly of thermal fuse and two MOVs and the heat-conducting compound. This provides an economical means of securely mounting the thermal fuse while ensuring efficient heat transfer from an overheated MOV to the thermal fuse.

An alternative method of installing the thermal fuse is shown in FIG. 5. A thermal fuse 24 is placed into a socket or attached with screws or clips between two MOVs 38,39. Then a clip 53 is placed over the assembly of two MOVs with the thermal fuse between them. The clip holds the MOVs in close thermal contact with the thermal fuse, and also helps keep the thermal fuse in place. The clip can be of metal or another suitable material.

Another alternative method of installing the thermal fuse is shown in FIG. 6. A thermal fuse 24 is placed into a socket or attached with screws or clips between two MOVs 38,39. Then a thermal epoxy 54 is applied to cover the thermal fuse and the adjacent MOVs.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more”. All structural and functional equivalents to the elements of the above-described preferred embodiment and additional embodiments that are known to those of ordinary skill in the art are hereby expressly incorporated by reference and are intended to be encompassed by the present claims. Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, it should be readily apparent to those of ordinary skill in the art that various changes and modifications in form, semiconductor material, and fabrication material detail may be made without departing from the spirit and scope of the inventions as set forth in the appended claims. No claim herein is to be construed under the provisions of 35 U.S.C. 112, sixth paragraph, unless the element is expressly recited using the phrase “means for”.

What is claimed:

1. An over-voltage protection apparatus, comprising:
an over-voltage and over-current protection circuit combination electrically coupled across at least one electrical input power configuration, said configuration selected from input power configurations consisting of hot line to neutral configuration, hot line to ground configuration and neutral to ground configuration;
said over-voltage and over-current protection circuit combination comprising at least one primary over-voltage sensitive device and a thermal sensitive disconnect device;
said at least one primary over-voltage sensitive device and said thermal sensitive disconnect device being physically packaged in a mechanical packaging arrangement such that heat generated by over-voltage protection action is thermally induced to trigger a disconnect action by said thermal sensitive disconnect device.

2. An over-voltage protection apparatus as described in claim 1, wherein:
said at least one primary over-voltage sensitive device comprises a metal oxide varistor.

3. An over-voltage protection apparatus as described in claim 1, wherein:
said thermal sensitive disconnect device comprises a thermal fuse.

4. An over-voltage protection apparatus as described in claim 1, wherein:
said mechanical packaging arrangement comprising attachment means for attaching said thermal sensitive disconnect device, said at least one primary over-voltage sensitive device and said thermal sensitive disconnect device being engulfed in a heat conducting compound, and a thermal blanket means for enclosing said heat conducting compound engulfed assembly consisting of said at least one primary over-voltage sensitive device and said thermal sensitive disconnect device.

5. An over-voltage protection apparatus as described in claim 4, wherein:
said attachment means being selected from attachment devices consisting of sockets, screws, and clips;
said heat conducting compound comprises a thermal grease; and
said thermal blanket comprises mylar tape.

6. An over-voltage protection apparatus as described in claim 1, wherein:
said mechanical packaging arrangement comprising attachment means for attaching said thermal sensitive disconnect device, said at least one primary over-voltage sensitive device and said thermal sensitive disconnect device being mounted in a heat conducting relationship using a clip.

7. An over-voltage protection apparatus as described in claim 6, wherein:
said attachment means being selected from attachment devices consisting of sockets, screws, and clips.

8. An over-voltage protection apparatus as described in claim 1, wherein:
said mechanical packaging arrangement comprising attachment means for attaching said thermal sensitive disconnect device, and said at least one primary over-voltage sensitive device and said thermal sensitive disconnect device being mounted in a heat conducting relationship using a thermal epoxy.

9. An over-voltage protection apparatus as described in claim 8, wherein:
said attachment means being selected from attachment devices consisting of sockets, screws, and clips.

10. An over-voltage protection apparatus as described in claim 1, wherein:
said mechanical packaging arrangement comprising attachment means for attaching said thermal sensitive disconnect device, said at least one primary over-voltage sensitive device and said thermal sensitive disconnect device being mounted in a heat conducting relationship using a clip.

11. An over-voltage protection apparatus as described in claim 1, further comprising:
over-voltage indicator lights and audio warning buzzer.

12. An over-voltage protection apparatus as described in claim 1, wherein said over-voltage and over-current protection circuit combination further comprises:
at least one secondary over-voltage sensitive device, said at least one secondary over-voltage sensitive device being physically packaged separately from said at least one primary over-voltage sensitive device and said thermal sensitive disconnect device.

13. An over-voltage protection apparatus as described in claim 12, wherein:
said at least one primary over-voltage sensitive device being electrically rated for responding to a lower magnitude of over-voltage condition than said at least one secondary over-voltage sensitive device.

14. An over-voltage protection apparatus as described in claim 13, wherein:
said at least one primary over-voltage sensitive device and said at least one secondary over-voltage sensitive device comprise metal oxide varistors.

15. An over-voltage protection apparatus as described in claim 12, said apparatus further comprising:
an impedance device selected from a group of impedance devices consisting essentially of inductors and resistors, said impedance device being electrically connected between said at least one primary over-voltage sensitive device and said at least one secondary over-voltage sensitive device, said impedance device being operative for ensuring proper over-voltage protection triggering action by an appropriate one of said at least one primary over-voltage sensitive device and said at least one secondary over-voltage sensitive device.

16. An over-voltage protection apparatus as described in claim 15, wherein:
said impedance device being rated at greater than 1 Ohm at frequencies higher than 10 KHz.

17. An over-voltage protection apparatus, comprising:
an over-voltage and over-current protection circuit combination electrically coupled across at least one electrical input power configuration, said configuration selected from input power configurations consisting of hot line to neutral configuration, hot line to ground configuration and neutral to ground configuration;
said over-voltage and over-current protection circuit combination comprising at least one primary over-voltage sensitive device, at least one secondary over-voltage sensitive device and a thermal sensitive disconnect device;
said at least one primary over-voltage sensitive device and said thermal sensitive disconnect device being physically packaged in a mechanical packaging arrangement such that heat generated by over-voltage protection action is thermally induced to trigger a disconnect action by said thermal sensitive disconnect device.

18. An over-voltage protection apparatus as described in claim 17, wherein:
said at least one primary over-voltage sensitive device and said at least one secondary over-voltage sensitive device comprise metal oxide varistors.

19. An over-voltage protection apparatus as described in claim 17, wherein:
said thermal sensitive disconnect device comprises a thermal fuse.

20. An over-voltage protection apparatus as described in claim 17, wherein:
said mechanical packaging arrangement comprising attachment means for attaching said thermal sensitive disconnect device, said at least one primary over-voltage sensitive device and said thermal sensitive disconnect device being engulfed in a heat conducting compound, and a thermal blanket means for enclosing said heat conducting compound engulfed assembly consisting of said at least one primary over-voltage sensitive device and said thermal sensitive disconnect device.

21. An over-voltage protection apparatus as described in claim 20, wherein:
said attachment means being selected from attachment devices consisting of sockets, screws, and clips;
said heat conducting compound comprises a thermal grease; and
said thermal blanket comprises mylar tape.

22. An over-voltage protection apparatus as described in claim 17, wherein:
said mechanical packaging arrangement comprising attachment means for attaching said thermal sensitive disconnect device, said at least one primary over-voltage sensitive device and said thermal sensitive disconnect device being mounted in a heat conducting relationship using a clip.

23. An over-voltage protection apparatus as described in claim 22, wherein:
said attachment means being selected from attachment devices consisting of sockets, screws, and clips.

24. An over-voltage protection apparatus as described in claim 17, wherein:
said mechanical packaging arrangement comprising attachment means for attaching said thermal sensitive disconnect device, and said at least one primary over-voltage sensitive device and said thermal sensitive disconnect device being mounted in a heat conducting relationship using a thermal epoxy.

25. An over-voltage protection apparatus as described in claim 24, wherein:
said attachment means being selected from attachment devices consisting of sockets, screws, and clips.

26. An over-voltage protection apparatus as described in claim 17, further comprising:
over-voltage indicator lights and audio warning buzzer.

27. An over-voltage protection apparatus as described in claim 17, wherein:
said at least one primary over-voltage sensitive device being electrically rated for responding to a lower magnitude of over-voltage condition than said at least one secondary over-voltage sensitive device.

28. An over-voltage protection apparatus as described in claim 17, said apparatus further comprising:
an impedance device selected from a group of impedance devices consisting essentially of inductors and resistors, said impedance device being electrically connected between said at least one primary over-voltage sensitive device and said at least one secondary over-voltage sensitive device, said impedance device being operative for ensuring proper over-voltage protection triggering action by an appropriate one of said at least one primary over-voltage sensitive device and said at least one secondary over-voltage sensitive device.

29. An over-voltage protection apparatus as described in claim 28, wherein:
said impedance device being rated at greater than 1 Ohm at frequencies higher than 10 KHz.

30. An over-voltage protection apparatus, comprising:
an over-voltage and over-current protection circuit combination electrically coupled across at least one electrical input power configuration, said configuration selected from input power configurations consisting of hot line to neutral configuration, hot line to ground configuration and neutral to ground configuration;
said over-voltage and over-current protection circuit combination comprising at least one primary over-voltage sensitive device, at least one secondary over-voltage sensitive device and a thermal sensitive disconnect device;
said at least one primary over-voltage sensitive device and said thermal sensitive disconnect device being physically packaged in a mechanical packaging arrangement such that heat generated by over-voltage protection action is thermally induced to trigger over-current protection action by said thermal sensitive disconnect device; and
an impedance device selected from a group of impedance devices consisting essentially of inductors and resistors, said impedance device being electrically connected between said at least one primary over-voltage sensitive device and said at least one secondary over-voltage sensitive device, said impedance device being operative for ensuring proper over-voltage protection triggering action by an appropriate one of said at least one primary over-voltage sensitive device and said at least one secondary over-voltage sensitive device.

31. An over-voltage protection apparatus as described in claim 30, wherein:
said at least one primary over-voltage sensitive device and said at least one secondary over-voltage sensitive device comprise metal oxide varistors.

32. An over-voltage protection apparatus as described in claim 30, wherein:
said thermal sensitive disconnect device comprises a thermal fuse.

33. An over-voltage protection apparatus as described in claim 30, wherein:
said mechanical packaging arrangement comprising attachment means for attaching said thermal sensitive disconnect device, said at least one primary over-voltage sensitive device and said thermal sensitive disconnect device being engulfed in a heat conducting compound, and a thermal blanket means for enclosing said heat conducting compound engulfed assembly consisting of said at least one primary over-voltage sensitive device and said thermal sensitive disconnect device.

34. An over-voltage protection apparatus as described in claim 33, wherein:
said attachment means being selected from attachment devices consisting of sockets, screws, and clips;
said heat conducting compound comprises a thermal grease; and
said thermal blanket comprises mylar tape.

35. An over-voltage protection apparatus as described in claim 30, wherein:
said mechanical packaging arrangement comprising attachment means for attaching said thermal sensitive disconnect device, said at least one primary over-voltage sensitive device and said thermal sensitive disconnect device being mounted in a heat conducting relationship using a clip.

36. An over-voltage protection apparatus as described in claim 35, wherein:
said attachment means being selected from attachment devices consisting of screws and clips.

37. An over-voltage protection apparatus as described in claim 30, wherein:
said mechanical packaging arrangement comprising attachment means for attaching said thermal sensitive disconnect device, and said at least one primary over-voltage sensitive device and said thermal sensitive disconnect device being mounted in a heat conducting relationship using a thermal epoxy.

38. An over-voltage protection apparatus as described in claim 37, wherein:
said attachment means being selected from attachment devices consisting of sockets, screws, and clips.

39. An over-voltage protection apparatus as described in claim 30, further comprising:
over-voltage indicator lights and audio warning buzzer.

40. An over-voltage protection apparatus as described in claim 30, wherein:
said at least one primary over-voltage sensitive device being electrically rated for responding to a lower magnitude of over-voltage condition than said at least one secondary over-voltage sensitive device.

41. An over-voltage protection apparatus as described in claim 30, wherein:
said impedance device being rated at greater than 1 Ohm at frequencies higher than 10 KHz.

42. A method for generating an over-voltage protection condition, said method comprising the steps of:
providing an over-voltage and over-current protection circuit combination, said combination being electrically coupled across at least one electrical input power configuration, said configuration being selected from input power configurations consisting of hot line to neutral configuration, hot line to ground configuration and neutral to ground configuration;
providing said over-voltage and over-current protection circuit combination comprising at least one primary over-voltage sensitive device and a thermal sensitive disconnect device;
providing said at least one primary over-voltage sensitive device and said thermal sensitive disconnect device physically packaged in a mechanical packaging arrangement such that heat generated by over-voltage protection action is thermally induced to trigger a disconnect action by said thermal sensitive disconnect device.

43. A method for generating an over-voltage protection condition as described in claim 42, wherein said step of providing said at least one primary over-voltage sensitive device comprises providing at least one metal oxide varistor.

44. A method for generating an over-voltage protection condition as described in claim 42, wherein said step of providing said thermal sensitive disconnect device comprises providing a thermal fuse.

45. A method for generating an over-voltage protection condition as described in claim 42, wherein said step of providing said mechanical packaging arrangement comprising providing attachment means for attaching said thermal sensitive disconnect device, providing said at least one primary over-voltage sensitive device and said thermal sensitive disconnect device engulfed in a heat conducting compound, and providing a thermal blanket means for enclosing said heat conducting compound engulfed assembly consisting of said at least one primary over-voltage sensitive device and said thermal sensitive disconnect device.

46. A method for generating an over-voltage protection condition as described in claim 45, wherein:
said step of providing said mechanical packaging arrangement comprising
providing said attachment means for attaching said thermal sensitive disconnect device as an attachment means selected from attachment devices consisting of sockets, screws, and clips,
providing said heat conducting compound as a thermal grease, and
providing said thermal blanket as mylar tape.

47. A method for generating an over-voltage protection condition as described in claim 42, wherein said step of providing said mechanical packaging arrangement comprising providing attachment means for attaching said thermal sensitive disconnect device, and providing said at least one primary over-voltage sensitive device and said thermal sensitive disconnect device mounted in a heat conducting relationship using a clip.

48. A method for generating an over-voltage protection condition as described in claim 47, wherein:
said step of providing said mechanical packaging arrangement comprising providing said attachment means for attaching said thermal sensitive disconnect device as an attachment means selected from attachment devices consisting of sockets, screws, and clips.

49. A method for generating an over-voltage protection condition as described in claim 42, wherein:
said step of providing said mechanical packaging arrangement comprising providing attachment means for attaching said thermal sensitive disconnect device, and
providing said at least one primary over-voltage sensitive device and said thermal sensitive disconnect device mounted in a heat conducting relationship using a thermal epoxy.

50. A method for generating an over-voltage protection condition as described in claim 49, wherein:
said step of providing said mechanical packaging arrangement comprising providing said attachment means for attaching said thermal sensitive disconnect device as an attachment means selected from attachment devices consisting of sockets, screws, and clips.

51. A method for generating an over-voltage protection condition as described in claim 42, wherein said method further comprises the step of providing over-voltage indicator lights and an audio warning buzzer.

52. A method for generating an over-voltage protection condition as described in claim 42, wherein said method further comprises the step of providing said over-voltage and over-current protection circuit combination further comprising:
at least one secondary over-voltage sensitive device, said at least one secondary over-voltage sensitive device being physically packaged separately from said at least one primary over-voltage sensitive device and said thermal sensitive disconnect device, said at least one primary over-voltage sensitive device being electrically rated for responding to a lower magnitude of over-voltage condition than said at least one secondary over-voltage sensitive device.

53. A method for generating an over-voltage protection condition as described in claim 42 wherein said method further comprises the step of providing an impedance device selected from a group of impedance devices consisting essentially of inductors and resistors, said impedance device being electrically connected between said at least one primary over-voltage sensitive device and said at least one secondary over-voltage sensitive device, said impedance device being operative for ensuring proper over-voltage protection triggering action by an appropriate one of said at least one primary over-voltage sensitive device and said at least one secondary over-voltage sensitive device.

54. A method for generating an over-voltage protection condition as described in claim 53 wherein said impedance device being rated at greater than 1 Ohm at frequencies higher than 10 KHz.
